(19) United States
(12) Patent Application Publication
(10) Pub. No.: US 2008/0109398 A1
(43) Pub. Date: May 8, 2008

(54) Mapping Tool and Method of Use Thereof

(76) Inventor: Jacqueline Monique Harter, Western Australia (AU)

Correspondence Address: DUANE MORRIS, LLP;IP DEPARTMENT, 30 SOUTH 17TH STREET, PHILADELPHIA, PA, 19103-4196, US

(21) Appl. No.: 11/628,815

(22) PCT Filed: Jun. 7, 2005
(86) PCT No.: PCT/AU05/00806

§ 371 Date: Dec. 7, 2006

Related U.S. Application Data
(60) Provisional application No. 60/591,374, filed on Jul. 27, 2004.

(30) Foreign Application Priority Data
Jun. 7, 2004 (AU) 2004903046
Nov. 18, 2004 (AU) 2004906584

(51) Int. Cl. G06F 17/30

(52) U.S. Cl. 707/2; 707/E17.014

(57) ABSTRACT

The present invention provides a mapping tool and method of use thereof to map, assess and improve the nature and dynamics of situations and relationships between people on an interpersonal and intrapersonal level and across a variety of fields, particularly, but not limited to, those relationships or situations that result in an emotional response. The mapping tool further provides the means to identify those areas at an interpersonal and intrapersonal level and across a variety of fields which may be strengthening or weakening an individual or a situation or relationship. The mapping tool further provides the means to identify understand and modify the emotional factors present in various situations and relationships, and their impact on different means and styles of communication. The mapping tool further provides the means to assess and facilitate the development of the emotional intelligence of a person or a group of persons, thus reducing the level of emotional stress and promoting empathy. The mapping tool further provides the means to identify and understand the interplay between the various factors involved in a situation or relationship and the level at which they may be expressed or suppressed. The mapping tool further provides the means to evaluate understand and facilitate the modification of conditional patterns of behaviour. The mapping tool further provides the means to identify understand and facilitate the resolution of conflicting personal, social or organisational situations and relationships and facilitate the identification of solutions. The mapping tool further provides the means to train a person or a group of persons in the prevention of conflicting situations or relationships. The mapping tool further provides the means to assist a person or a group of persons in making adequate choices when a decision needs to be made at an interpersonal or intrapersonal level.

### FIELD OF THE INVENTION

The present invention relates to a tool and method useful to map, assess and improve the nature and dynamics of situations and relationships between people on an interpersonal and intrapersonal level and across a variety of fields, particularly situations or relationships between people that result in an emotional response. The tool can be used to map other social or organisational situations and relationships, including businesses.

### BACKGROUND

Traditional assessment models and tools currently available tend to rely on verbal or written clues in the form of a question or sentence which do not take into account the lack of communication skills or learning difficulties experienced by a range of people, especially boys and men, and tend to identify what a client thinks rather than what a client feels. Furthermore, these models and tools do not provide the means to identify understand and/or facilitate the modification of the various factors involved in a situation or relationship in order to create an improvement.

When a person is under emotional stress, the neural circuitry reverses to survival mode, overriding neural pathways needed for the cognitive abilities required to process the verbal or written clues in the form of questions or sentences.

Such models are initiated and therefore subject to the primary interpretation of the counsellor and/or a conscious or subconscious reaction of a client to verbal or written clues in the form of questions or sentences.

Some tools which seek to address the affective dimension do so separately from other factors, do not identify whether the affective dimension is analysed at an interpersonal or intrapersonal level, and none of those tools differentiate between feelings, emotional states, and related behaviour and do not facilitate the understanding of their relatedness. These tools which might seem to rely on single words still require the use of verbal or written clues in the form of questions and sentences.

It is therefore the general object of the present invention to provide a mapping tool useful to map, assess and improve the nature and dynamics of situations and relationships between people on an interpersonal and intrapersonal level and across a variety of fields, particularly, but not limited to, situations or relationships between people that result in an emotional response, a tool which is by nature totally client driven and non judgemental, simple to use and interpret, yet offers equal opportunity for expression and identification of a wide range of factors and their relatedness through an interactive process supported by visualisation, observation and reflexion.

In order to provide a better understanding, a preferred embodiment of the present invention will now be described in greater detail, by way of example only, with reference to the accompanying drawings, in which:

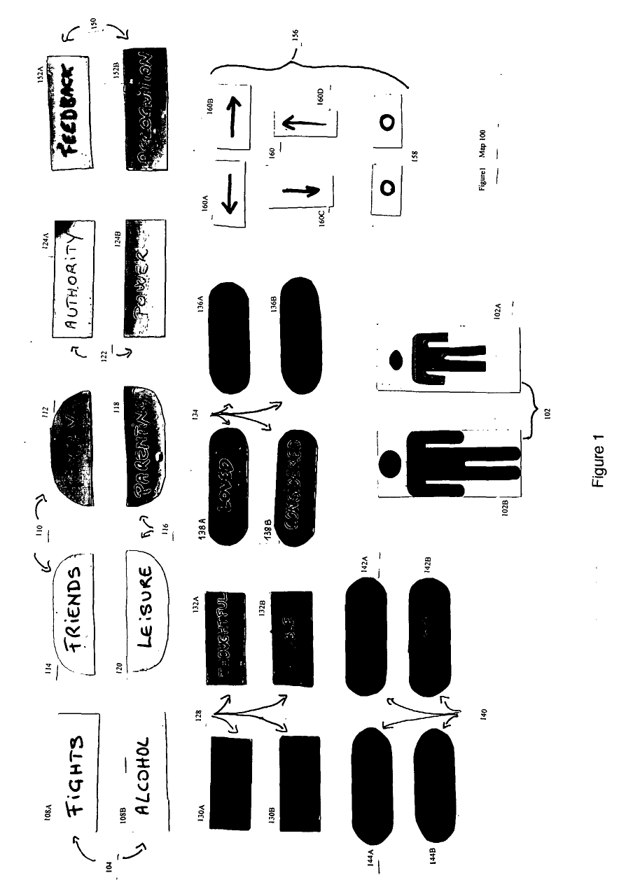

FIG. 1 is a schematic representation of one embodiment of the tool of the present invention;

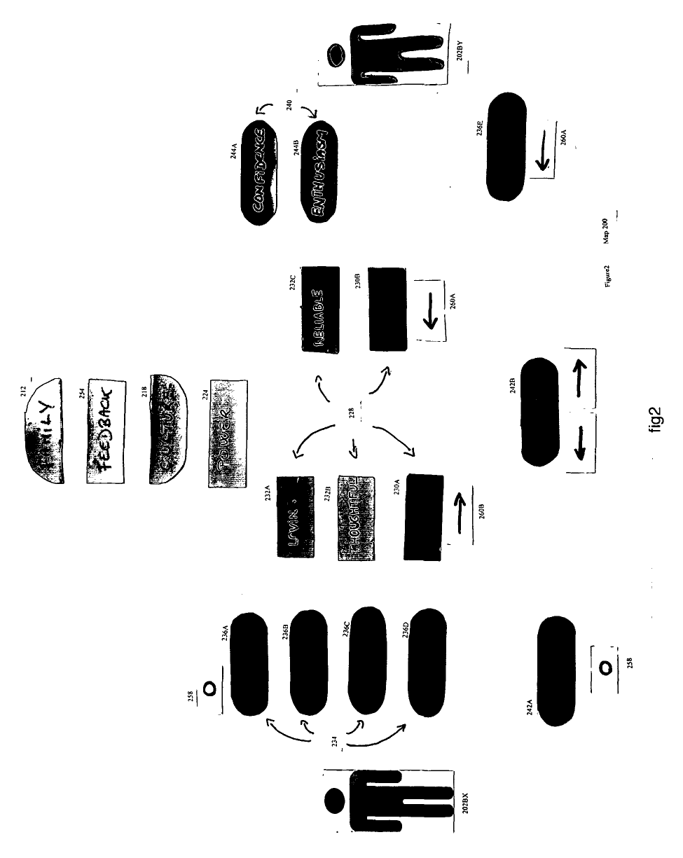

FIG. 2 is an example of use of an embodiment of the present invention;

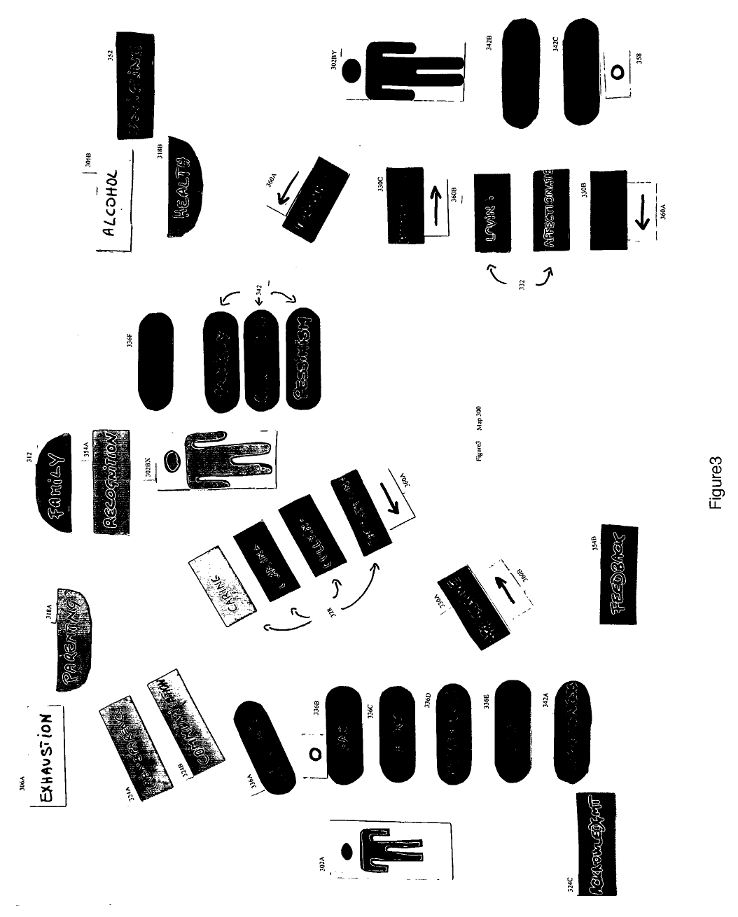

FIG. 3 is an example of use of an embodiment of the present invention;

Referring to FIG. 1 there is shown a tool 100 comprising a first set of objects 102, a second set of objects 104, a third set of objects 110, a fourth set of objects 116, a fifth set of objects 122, a sixth set of objects 128, a seventh set of objects 134, an eight set of objects 140, an eleventh set of optional objects 150, and a twelfth set of objects 156. In one embodiment the objects are tiles, in another embodiment the objects are icons on a computer video display.

The first set of objects, for example 102A and 102B relate to people. In this example 102A represents an older child and 102B represents an adult. The first sets of objects have an image shaped like people and sized to represent the appropriate type of person.

The second set of objects 104 are rectangular in shape, some being dark in shade and some, objects 108 being light in shade. The second set of objects relate to symptoms. The second set of objects is yellow in colour. Each object related to a different symptom. In this example object 108A relates to the symptom of “FIGHTS” and object 108B relates to the symptom of “ALCOHOL”. These objects are shown as examples and not intended to be a comprehensive list.

The third set of objects 110 are shaped with a semicircle on the top and relate to contexts. A first object 112 is dark in shade and relates to disempowering contexts. A second object 114 is light in shade and relates to empowering context. The third sets of object are green in colour. Some examples of these are objects 112 which is the disempowering context of “FAMILY” and object 114 which is the empowering context of ‘FRIENDS’. Contexts may be empowering or disempowering as perceived by the user of the tool.

The fourth set of objects 116 are shaped with a semicircle on the bottom and relate to context area. A first object 118 is dark in shade and green in colour and relates to disempowering context area. A second object 120 is light in shade and green in colour and relates to empowering context area. Examples of context area objects are object 118 which relates to the disempowering context area of ‘PARENTING’ as may be perceived by the user, and object 120 which relates to the empowering context area of ‘LEISURE’.

The fifth sets of objects 122 are rectangular and orange in colour and relate to themes. Objects 124 are dark in shade and relate to disempowering themes. Objects 126 are light in shade and relate to empowering themes. In this example object 124A relates to the disempowering theme of ‘AUTHORITY’ and object 124B relates to the disempowering theme of ‘POWER’.

The sixth set of objects 128 in this example are rectangles and relate to behaviours. A first group 130 of the sixth set of objects 128 are dark in shade and relate to negative or destructive behaviours. A second group 132 are light in shade and relate to positive or constructive behaviours.

The behaviour objects are blue in colour with the destructive behaviour object 130 being dark blue in colour and the constructive behaviour objects 132 being light blue in colour. Some examples of these are object 130A showing the destructive behaviour of ‘IGNORING’; object 130B relates to the destructive behaviour of (being) ‘UNCOOPERATIVE’; object 132A relates to the constructive behaviour of ‘THOUGHTFUL’; and object 132B relates to the constructive behaviour of ‘RELIABLE’.

The seventh and eight sets of objects generally relate to emotional symptoms. The seventh set of objects 134 are ovaloid in shape and red in colour and relate to feelings. Feelings tend to be transient. A first group 136 of the seventh set of objects 134 are dark in shade and relate to destructive feelings. The second group 138 of the seventh set of objects 134 relate to constructive feelings and are light in shade. Examples of feeling objects are: object 136A relates to the destructive feeling of ‘HURT’; object 136B relates to the destructive feeling of ‘UNIMPORTANT’; object 138A relates to the constructive feeling of ‘LOVED’; and object 138B relates to the constructive feeling of ‘CONSIDERED’.

The eighth set of objects 140 in this example are ovaloid in shape, pink in colour and relate to moods or emotional states. Moods or emotional states are symptoms that tend to be longer lasting than feelings. A first group of objects 142 of the eight set of objects 140 relate to destructive moods and are darker in shade. A second group 144 of the eight set of objects 140 relate to constructive moods and are lighter in shade. Examples of the mood objects are: object 142A relates to the destructive mood of ‘RESENTMENT’; object 142B relates to the destructive mood of ‘ANGER’, object 144A relates to the constructive mood of ‘CONFIDENCE’ and object 144B relates to the constructive mood of ‘ENTHUSIASM’.

The eleventh sets of objects 150 in this example are rectangle in shape and green in colour and relate to potential solutions. A first group of objects 152 is dark in colour and relates to solutions with a lower degree of sustainability. A second group of objects 154 is light in colour and relates to solutions with a high degree of sustainability. Examples of the solution objects are: object 152A relates to the solution of ‘FEEDBACK’ and object 152B relates to the solution of (providing) ‘RECOGNITION’.

The twelfth set of objects 156 are white in colour and relate to the direction of movement or absence of movement of some of the objects comprised in the tool. A first group of objects 158 of the twelfth set of objects 156 represent an absence of movement, and a second group of objects 160 of the twelfth group of objects 156 represent a direction. Examples of objects 156 are: 158 relate to absence of movement; 160A relates to a direction from right to left, 160B relates to a direction from left to right, 160C relates to a direction from up to down and 160D relates to a direction from down to up.

This list is not intended to be comprehensive and indeed some of the objects may be left blank for the person to add their own symptom, context, context area, themes, behaviour, feelings, moods, solution or direction. It is noted that in some versions where objects such as objects 128 may be shaped as an arrow to represent a direction, these objects may point in a variety of directions.

It is also noted that instead of words, pictures can be used to represent the particular subject. Such a version is useful for children or those with mental disability or language challenged.

Emotional stress has an enormous impact on physical and mental health, and the present invention is useful in achieving emotional competency and thus promoting resilience in a variety of personal, social or work related situations and relationships.

Emotional stress limits our conscious brain function and triggers reactions which are based on past patterns of experience and related behaviours.

In the present invention, the use of various colours and shapes is thought to activate alternate brain function, and the process of choosing a word or picture is thought to activate the frontal lobes, the seat of new choices and alternatives. The combination of the above triggers non-judgemental memory and allows the user to “see the whole picture”, thus expanding limited perception and accessing new alternatives. This also facilitates empathy as the user or users are able to identify factors impacting on another person's viewpoint.

The spontaneity provided by the present invention allows the user to access subconscious memory thus becoming aware of factors not previously identified.

The series of actions involved in constructing the map engages connections between various brain functions which allow the user to reach a level of awareness no longer limited by past experiences, initiating an ability to make conscious choices to improve the situation or relationship, thereby reducing the level of emotional stress.

As the overall shade of the map lightens over successive uses a positive change can be observed, which in itself can reinforce the process is working and thereby provides encouragement.

The ability to identify empowering and constructive factors allow the user to balance a negative perception of a situation with positive aspects.

As mentioned previously, the objects may be in the form of tiles in one embodiment and they may be used on a backing board which forms a sheet on which to create a map. Either the backing board or the tiles may be magnetised and the other is magnetically attractive. In this way the tiles can be arranged on the backing board to produce a map of a situation and/or a map of the nature and dynamics of relationships between people. Maps may be recorded by manual or photographic means. Various scores may be obtained to assess negative or positive outlooks, resilience ability, emotional competency, communication means and styles and/or progress or a combination of the above. Scores may be obtained by the differences between dark and light shades within a given category. An overall score combining all factors and therefore representative of client's values, culture, beliefs, thoughts and experiences facilitates an interpretation specific to an individual, situation or relationship, thus providing the best background for a sustainable solution.

Professionals operating in different frameworks can easily create an interpretation scale in relation to their particular framework.

This tool can have a range of versions and be used in a variety of contexts and client groups as will be described further below.

In another embodiment the objects may be icons displayed on a display device such as computer screen which may be selected and moved around the display using a click, drag and drop technique. The background of the display forms the map sheet. Software may be provided for loading onto a computer which configures the computer to provide an electronic version of the tool. In this version the objects may be selected either from a menu in which case they appear for placement upon selection or they may already be present on the screen for selection and placed to form a map.

The computer version can be provided on CD ROM and installed on the computer or may be provided on-line via the internet. The electronic version may have added functionality in that it can assess the overall shade of a set or category of objects, or the overall shade of the map created, by for example, adding up the number of light shade objects and subtracting the number of dark shade objects to produce a score. A negative score would indicate the person or group of persons or situation has a more negative outlook whereas a positive score would indicate a more positive outlook. In addition, particular objects relating to particular behaviours, emotions and feelings could be rated more heavily or lightly depending on the particular aspect represented. Furthermore the map could be analysed to identify people or situations at risk of interpersonal or intrapersonal conflict and online or face to face professional intervention may be provided.

Furthermore a range of maps may be analysed to provide data regarding particular or recurring occurrences within a specific context. This data could then be interpreted to facilitate service delivery within a specific context or geographical area.

The process of placement of the objects to form a map will now be described.

A relationship map relates to at least one person, usually two or more people. Thus the people involved are represented using the first group of objects 102. The objects relating to people are spaced apart. The second group of objects 104 are then used to identify the symptoms apparent for one or more of the first group of objects or as a common symptom concerning a group or combination of people and are placed accordingly. If the symptom relates to only one of the people represented then the symptom is placed near the relevant person's object instead of between the person's object and another person's object.

The third group of objects 110 are then used to identify the context in which the situation is occurring. This can be related to one object from the first group of object 102, in which case the symptom is placed near the relevant person's object, or it can be related to the situation as a whole in which case the object from the third group of object is placed at the top of the map.

The fourth group of objects 116 are then used to identify in which area of a context the situation is occurring, and is placed according to the contexts selected above.

The fifth group of objects 122 are then used to identify the themes related to the contexts and context area objects as selected previously.

The behaviour objects 128 are then placed near the person exhibiting the behaviour, and where the behaviour objects are not shaped to represent direction, an object from the twelfth group of objects 156 is then selected to indicate towards which person the behaviour is exhibited. The behaviour may be exhibited towards one or a number of persons.

Where the process is being conducted by two people or more, the behaviour object may lead to a discovery process by each person. Each person will discover the behaviour that they believe they exhibit to the other people and the behaviour that other people believe are exhibited towards them.

The feelings objects 134 are placed beside each person object and map out the feelings felt by each person about themselves or their situation or another person. Naturally this will represent a point of view. Where two people are involved in creating the map and they are each representing their emotional relationship, then this can be a discovery process in which each person discovers the feelings that the other person has about them, as well as their own feelings about the other person represented by the object 102 or the issue.

The mood/emotional states objects 140 can be placed next to each person representing the perceived mood.

The senses objects 146 can be placed next to a behaviour object and/or next to a feeling object to indicate which sense is activated by a particular behaviour or feeling. The sense object may lead to the discovery for example that what is perceived as a threatening behaviour is actually violent when the touch sense is involved and may lead to reversal of denial.

The values objects 148 may be used with or separately from the map to identify which values are important to any of the first group of objects.

The solutions objects 156 can be first identified by any of the first group of objects as what they would like to obtain or what solution they may consider appropriate, and can be placed between a context object and context area object to see if the solutions may be sustainable in the view of the context and context area.

An example of instant benefits from this process of identification of the nature and dynamics of the situation or relationship is by allowing users of this tool to understand at a glance which modifications may be desirable and/or possible, whether there is a particular factor as represented by the objects which is a trigger to the situation, how this trigger relates to other factors, which modifications they may be able to achieve by themselves and or whether they will require support.

Some examples of use of the tool will now be described in reference to FIGS. 2 and 3.

In FIG. 2 the tool has been used to produce a map 200 of a relationship between brother and sister. The female creates the map and is represented by the first person object 202BX. The second object 202BY represents the brother. Behaviour exhibited by each person (as perceived by the sister) is represented by the behaviours 128. For example person 202BX exhibits behaviours (objects 228) towards the second person including for example ‘THOUGHTFUL” (232B) and “UNCOOPERATIVE’ (230A). The second person exhibits behaviours (objects 228) towards the first person, including for example ‘RELIABLE’ (232C) and ‘IGNORING’ (230B). Other behaviours are shown but it is not necessary to describe them. It is noted that behaviours 232B and 232C are light in shade and represent constructive behaviours. Behaviours objects 230A and 230B are dark in shade and represent destructive behaviours. In this version, the direction of behaviours 230A, 232A and 232B is indicated by object 260B and the direction of behaviours 232C and 230B is indicated by object 260A. The theme between the first person and the second person is one of ‘POWER’ and is represented by the theme object 224 showing the word ‘POWER’.

The first person is experiencing feelings 234 of ‘HURT’ ‘UNAPPRECIATED’ and ‘UNIMPORTANT’. These are represented by objects 236A, 236B and 236C as dark in shade for negative feelings.

The second person is perceived to be feeling ‘FRUSTRATED’ as represented by feeling object 236E. The first person overall mood is ‘ANXIETY’ as represented by negative mood object 242A, whereas the second person's overall mood is of ‘ENTHUSIASM’ and ‘CONFIDENCE’ as represented by objects 244, which are positive moods. As a result of the “POWER” theme there is an overall mood of “ANGER” between the two people as represented by the object 242B.

The process of mapping out this relationship can be one of discovery where the first person comes to identify or empathise with the other person by the process of mapping the emotional situation/relationship out. It can also be a process of self discovery. It is useful for counsellors as it assists them to identify issues, which they can attempt to address by counselling one or both of the people. As a result of the process, the first person is able to understand the relation between feelings and behaviour.

Referring to FIG. 3, in this case the map represents relationship between three people, the first person represented by object 302BX, the second person by object 302BY and the third person being a young adult but feeling disempowered has chosen to be represented by a smaller shape object 302A. The symptom exhibited by the third person is “EXHAUSTION” as represented by object 306A.

The overall context of the situation as perceived by the third person is “FAMILY” as represented by object 312, and the context area as been identified as “PARENTING’ by object 318A. There are themes of “COMMUNICATION’ and “TRANSPARENCY” between the first and third person as represented by objects 334A and 324B, while a specific theme for the third person is “ACKNOWLEDGMENT” as represented by object 324C.

The context area concerning the second person (302BY) is “HEALTH” as represented by object 318B.

The first person exhibits the behaviour of “CARING” but the negative behaviours of “BULLYING” “BLAMING” and “THREATENING” to the third person as represented by behaviour objects 328. The second person exhibits positive behaviours of “LOVING” and “AFFECTIONATE”, as represented by objects 332, but the negative behaviour of “UNRELIABLE” as represented by object 330B.

The third person exhibits the behaviour of “AGGRESSIVE’ towards the first person, as represented by object 330. The first person feels “UNAPPRECIATED” as represented by object 336F. The third person feels “ATTACKED” in relation to the first person as represented by 336A, and feels “SAD” (336B) “HURT” (336C) “VULNERABLE” (336D) and “BETRAYED” (336E).

The third person is in a mood/emotional state of “HELPLESSNESS” as represented by object 342A. The second person is in a mood/emotional state of “GUILT” and “REGRET’ as represented by objects 342B and 342C. The first person is in a mood/emotional state of “ANXIETY” “RESENTMENT” and PESSIMISM” as represented by objects 342.

A particular embodiment of one of the version of the tool has in the first set of objects two adults, a teenager, a child, a toddler and an infant. There are 70 issue objects, 18 of which are context with a dark background colour, and 18 with a light background colour, 17 are themes with a dark background colour and another 17 with a light background colour and four (2 light, 2 dark are blank). The behaviours can be on 80 arrows, 15 of which are dark blue and point to the left, and 15 of which point to the right, 20 of which are light blue and point to the right and 20 of which are light blue and point to the left, 5 arrows are dark blue and can point either way and are left blank, 5 arrows are light blue and can point either way and are left blank. The feelings objects can be in the form of 68 ovaloids, 35 of which have a dark red background, 24 of which have a light red background, 4 have a dark background and are left blank, 4 have a light background and are left blank. The moods/emotional states can be in the set of 36 semicircles, 12 are of a light background, 18 of a dark background. There are 3 dark green that are left blank and 3 light green that are left blank. Additionally 36 rectangles can be provided on a white background which represents people who may be involved; these may include the user, a family member, friends, school teachers, work, or members of the community. In addition six circles depict each of the six senses. Furthermore 20 triangles can represent values.

A list of useful words for the objects for another embodiment of the tool is listed below. In this embodiment, the first set of objects has two small people shapes, two medium people shapes, two big people shapes and one group of people shape. There are 12 Physical symptoms with a light background colour, 2 of which are blanks, 12 Physical symptoms with a dark background colour, two of which are blanks, 9 Contexts with a light background colour, two of which are blanks, 9 Contexts with a dark background colour, 2 of which are blanks, 15 Context areas with a light background colour, two of which are blanks, 15 Contexts with a dark background colour, two of which are blanks, 23 Themes with a dark background colour, two of which are blanks, 23 Themes with a light background colour, two of which are blanks, 22 Solutions with a dark background colour, two of which are blanks, 22 Solutions with a light background colour, two of which are blanks, 20 Behaviours with a dark background colour, two of which are blanks, 18 Behaviours with a light background colour, two of which are blanks, 21 Feelings with a light background colour, two of which are blanks, 38 Feelings with a dark background colour, two of which are blanks, 13 Emotions with a light background colour, two of which are blanks, 17 Emotions with dark background colour, two of which are blanks.

Symptoms

| | | | |
|---|---|---|---|
| Sleep | Injuries | Irritability | Exhaustion |
| Appetite | Drugs | Violence | |
| Fights | Alcohol | Harassment | Performance |

Context

| | | | |
|---|---|---|---|
| Self | Peers | Family | School |
| Friends | Partner | Community | |

Context area

| | | | |
|---|---|---|---|
| Accommodation | Entertainment | Law | Work |
| Communication | Employment | Leisure | |
| Culture | Health | Parenting | |
| Education | Income | Transport | |

Themes

| | | | |
|---|---|---|---|
| | Commitment | Integrity | Safety |
| Acknowledgment | Control | Intimacy | Sexuality |
| Authority | Direction | Isolation | Status |
| Autonomy | Equality | Needs | Support |
| Belonging | Freedom | Power | Transparency |
| Boundaries | | Purpose | |

Solutions

| | | | |
|---|---|---|---|
| Allowance | Financial | Recognition | Technical |
| Budget | resources | Research | resources |
| Compromise | Incentives | Structural | Time |
| Discipline | Mentoring | resources | management |
| Feedback | Monitoring | Supervision | Training |

Behaviours, destructive

| | | | |
|---|---|---|---|
| | | Ignoring | Teasing |
| Arrogant | Contemptuous | Inconsiderate | Threatening |
| Avoiding | Deceitful | Indifferent | Uncooperative |
| Blaming | Destructive | Nagging | Unreliable |
| Bullying | Dismissive | Sarcastic | Withholding |

Behaviours, constructive

| | | | |
|---|---|---|---|
| Affectionate | Considerate | Engaging | Reliable |
| Attentive | Cooperative | Gentle | Supportive |
| Caring | Daring | Kind | Thoughtful |
| Comforting | Encouraging | Loving | Understanding |

Feelings, constructive

| | | | |
|---|---|---|---|
| Accepted | Brave | Excited | Loved |
| Adequate | Considered | Grateful | Needed |
| [symbol] | Equal | Important | Nurtured |
| Protected | Safe | Valued | Worthy |
| Proud | Special | Welcomed | |

Feelings, destructive

| | | | |
|---|---|---|---|
| Abused | Disappointed | Let Down | Scared |
| Annoyed | Deserted | Not Heard | Trapped |
| Ashamed | Embarrassed | Offended | Threatened |
| Attacked | Frightened | Overlooked | Unappreciated |
| Betrayed | Frustrated | Picked On | Unimportant |
| Bitter | Hurt | Put Upon | Unloved |
| Burdened | Humiliated | Rejected | Used |
| Deprived | Inadequate | Sad | Vulnerable |

Emotions, constructive

| | | | |
|---|---|---|---|
| Acceptance | Confidence | Fulfilment | Optimism |
| Appreciation | Enthusiasm | Hope | Trust |
| Boldness | Faith | Motivation | |

Emotions, destructive

| | | | |
|---|---|---|---|
| Anger | Grief | Indifference | Remorse |
| Anxiety | Guilt | Loss | Rigidity |
| Despair | Helplessness | Pessimism | Resentment |
| Fear | Hostility | Regret | |

It is noted that instead of words, pictures can be used to represent the particular subject. Such a version is useful for children or those with a disability.

This list is not intended to be comprehensive, and indeed some of the objects in each set or category of objects may be left blank while retaining their associated colour and shape for the user or users to add their own words or pictures. The colours and shapes described may be varied.

A list of useful words for the objects of another embodiment is listed below:

Symptoms
Rectangle
Yellow

| | | | |
|---|---|---|---|
| Absenteeism | Conflict | Harassment | Resignation |
| Breach | Constraints | Injuries | Setback |
| Bullying | Delays | Insubordination | Stress |
| Complaints | Discrimination | Obstruction | Tardiness |
| Concerns | Fixation | Permissiveness | |

Context
Semicircle Top
Green

| | | | |
|---|---|---|---|
| Administration | Finance | Production | Transport |
| Auditive | Management | Sales | |
| Distribution | Marketing | Service | |
| Export | Ordering | Technology | |

Context
Area
Semicircles bottom
Green

| | | | |
|---|---|---|---|
| Leadership | Productivity | Health | Procedures |
| Transport | Stock | Salary | Policies |
| Duties | Service | Equipment | Coordination |
| Guidelines | Rules | Qualifications | |
| Politics | Job description | Quota | |
| Volume | Team work | Safety | |

Themes
Rectangles
Orange

| | | | |
|---|---|---|---|
| Adhesion | Transparency | Communication | Status |
| Confidentiality | Control | Skills | Punctuality |
| Isolation | Authority | Needs | Ambition |
| Collaboration | Supervision | Interdependence | Autonomy |
| Accountability | Equality | Power | Performance |
| Synergy | Integrity | Boundaries | Values |
| Initiative | Clarity | Direction | Integrity |
| Information | Ethics | Purpose | |
| Access | Support | Culture | |

Solutions
Rectangle
Green

| | | | |
|---|---|---|---|
| Allowance | Feedback | Planning | Supervision |
| Audit | Financial | Praise | Technical |
| Budget | resources | Quality control | resources |
| Compensation | Human resources | Raise | Time |
| Compromise | Incentives | Research | management |
| Counselling | Mentoring | Structural | Training |
| Discipline | Monitoring | resources | |

Feelings, constructive
Ovaloids
Light red

| | | | |
|---|---|---|---|
| Accepted | Confident | Grateful | Worthy |
| Adequate | Considered | Valued | |
| Appreciated | Equal | Welcome | |

Feelings, destructive
Ovaloids
Dark red

| | | | |
|---|---|---|---|
| Afraid | Confused | Not heard | Trapped |
| Annoyed | Disappointed | Overlooked | Threatened |
| Attacked | Embarrassed | Overwhelmed | Unappreciated |
| Betrayed | Frustrated | Picked on | |
| Bored | Humiliated | Rejected | |
| Burdened | Inadequate | Scared | |

Emotions, constructive
Ovaloids
Light pink

| | | |
|---|---|---|
| Appreciation | Enthusiasm | Motivation |
| Boldness | Fulfilment | Optimism |
| Confidence | Hope | Trust |

Emotions, destructive
Ovaloids
Dark Pink

| | | | |
|---|---|---|---|
| Anger | Helplessness | Loss | Resentment |
| Anxiety | Hostility | Pessimism | |
| Fear | Indifference | Rigidity | |

Behaviours, constructive
Rectangles
Light blue

| | | | |
|---|---|---|---|
| Loyal | Cooperative | Consistent | Thoughtful |
| Supportive | Available | Creative | Tolerant |
| Flexible | Reliable | Attentive | |
| Focused | Efficient | Encouraging | |
| Considerate | Adaptable | Respectful | |

Behaviours, destructive
Rectangles
Dark blue

| | | | |
|---|---|---|---|
| Inconsistent | Threatening | Insubordinate | Disruptive |
| Inconsiderate | Unavailable | Avoiding | Intolerant |
| Inflexible | Rigid | Withholding | Sarcastic |
| Unreliable | Hostile | Daydreaming | |
| Uncooperative | Obstructive | Ignoring | |

This list again is intended to only be an example of words that can be used for the respective objects.

The tool can be accompanied with an instruction manual for personal use where the instruction manual includes a description of the meaning of the tiles according to their respective shape, colour, shade, word and/or image and depicts ways to use the tool for single or multiple users at a time.

Alternatively, or in addition, the instruction manual can be used for professional use which instructs a counsellor or the like or a human resource worker or the like on the manner of use of the tool with single or multiple clients at the same time. This tool is particularly useful to map emotional and/or mental and/or behavioural processes involved in a complex situation.

The use of the tool can increase the user's awareness, understanding and acceptance of feelings, moods and behaviours in themselves and others. It can be useful to understand the differences between feelings, emotions and behaviours and their interrelation, it can enhance the ability of the user to modify conditional patterns of behaviour in relation to themselves and/or others through an increase awareness, understanding and acceptance of how an where these patterns originated, of how and why the conditioning evolved and how related expectations produced by said conditioning were formed.

The user is able to prioritise issues to address its own needs not those identified by others. The user is able to identify which virtues are valued and this may differ from virtues valued by others. The user can reflect on what control they have on a situation and what can be modified.

The ability to identify feelings of others generates empathy as well as an awareness that it is the user's perception of other's feelings. This implies a subsequent reflection on why we believe these are the feelings others might experience. The reflection is upon perception what sens it involves, beliefs, systems and thinking patterns. The user can map family relationships and understand their behaviour and the user's subsequent reactions and personal beliefs and how these might affect their perception and expectations of subsequent relations.

The tool can reduce the incidence of emotional stress. It can assist to increase the occurrence and/or level of empathy. The tool can assist as a means of mediation between participants in a conflict resolution process. When the map has been produced the user can identify whether modification of behaviour would produce a change in their relationship to themselves or others and what factors may trigger or might help in said modification of behaviour. The user can identify alternative behaviour they wish others would adopt towards them. If their relationship changes over time periodic mapping of the person's situation can result in the overall shade of the map changing to a lighter shade, as different objects are selected in each successive mapping, which reflect the improving changes to feelings, emotions and behaviour.

It will be understood to persons skilled in the art of the invention that many modifications may be made without departing from the spirit and scope of the invention.

What is claimed is:

1. A mapping tool that is used to identify and map the range of factors, positive and/or negative, which impact on a situation or relationship where interpersonal or intrapersonal conflict is present, or has the potential to occur, and/or where interpersonal or intrapersonal decisions need to be made; how those factors interrelate and potential solutions; the mapping tool comprising: a plurality of objects classified in different sets with different categories for some sets, where some of the sets represent a range of factors, and one set represents potential solutions, and one set represents the direction of the movement of some of the factors (interpersonal) or absence of movement of some of the factors (intrapersonal); a means to display the selected objects wherein a plurality of said objects are arranged to map out a situation or relationship, and all the selected objects can be visualised simultaneously.

2. According to the mapping tool as recited in claim 1, there is provided a first set of objects relating to people, each of the first set of objects representing a different person or group of persons.

3. According to the mapping tool as recited in claim 1, there is provided a second set of objects relating to symptoms, each of the second set of objects representing a different symptom.

4. According to the mapping tool as recited in claim 1, there is provided a third set of objects relating to context, each of the third set of objects representing a different context.

5. According to the mapping tool as recited in claim 1, there is provided a fourth set of objects relating to context area, each of the fourth set of objects representing a different context area.

6. According to the mapping tool as recited in claim 1, there is provided a fifth set of objects relating to themes, each of the fifth set of objects representing a different theme.

7. According to the mapping tool as recited in claim 1, there is provided a sixth set of objects relating to behaviours, each of the sixth set of objects representing a different behaviour.

8. According to the mapping tool as recited in claim 1, there is provided a seventh set of objects relating to feelings, each of the seventh set of objects representing a different feeling.

9. According to the mapping tool as recited in claim 1, there is provided an eight set of objects relating to moods or emotional states, each of the eight set of objects representing a different mood or emotional state.

10. According to the mapping tool as recited in claim 1, there is provided a ninth set of objects relating to senses, each of the ninth set of objects representing a different sense.

11. According to the mapping tool as recited in claim 1, there is provided an tenth set of objects relating to values or virtues, each of the tenth set of objects representing a different value or virtue.

12. According to the mapping tool as recited in claim 1, there is provided an eleventh set of objects relating to solutions, each of the eleventh set of objects representing a different solution.

13. According to the mapping tool as recited in claim 1, there is provided a twelfth set of objects relating to the direction of the movement of some of the factors (interpersonal) or absence of movement of some of the factors (intrapersonal), each of the twelfth set of objects representing a different direction or an absence of movement.

14. According to the mapping tool as recited in claim 1, a range of versions of the said mapping tool to be used in different situations or relationships, whether personal/social, organisational/industrial or career development, and where said versions may be adapted for a range of ages.

15. According to the mapping tool as recited in claims 2 to 13, the objects in each set or categories have a word and/or image thereon, as relating to a particular adaptation and/or version, each word and/or image representing a particular type of person, symptom, context, context area, theme, behaviour, feeling, emotional state, sense, virtue, solution and movement or absence of movement, respectively.

16. According to the mapping tool as recited in claim 3, said objects representing symptoms are represented by a particular shape and/or a particular colour.

17. According to the mapping tool as recited in claims 3 and 16, different shades of the same colour as attributed to symptoms may be used to represent the magnitude of the symptoms, a light shade representing a minor symptom and a darker shade representing a major symptom.

18. According to the mapping tool as recited in claim 4, said objects representing contexts are represented by a particular shape and/or a particular colour.

19. According to the mapping tool as recited in claims 4 and 18, different shades of the same colour as attributed to contexts may be used to represent empowerment or disempowerment effect of said contexts, a light shade representing an empowering context and a dark shade representing a disempowering context.

20. According to the mapping tool as recited in claim 5, said objects representing context areas are represented by a particular shape and/or a particular colour.

21. According to the mapping tool as recited in claim 5 and 20, different shades of the same colour as attributed to context areas may be used to represent empowerment or disempowerment effect of said contexts areas, a light shade representing an empowering context area and a dark shade representing a disempowering context area.

22. According to the mapping tool as recited in claim 6, said objects representing themes are represented by a particular shape and/or a particular colour.

23. According to the mapping tool as recited in claim 6 and 22, different shades of the same colour as attributed to themes may be used to represent empowerment or disempowerment effect of said themes, a light shade representing an empowering theme and a dark shade representing a disempowering theme

24. According to the mapping tool as recited in claim 7, said objects representing behaviours are represented by a particular shape and/or a particular colour.

25. According to the mapping tool as recited in claim 7 and 24, different shades of the same colour as attributed to behaviours are used to represent constructive or destructive behaviours, a light shade representing a constructive behaviour and a dark shade representing a destructive behaviour.

26. According to the mapping tool as recited in claim 8, said objects representing feelings are represented by a particular shape and/or a particular colour.

27. According to the mapping tool as recited in claim 8 and 26, different shades of the same colour as attributed to feelings are used to represent constructive or destructive feelings, a light shade representing a constructive feeling and a dark shade representing a destructive feeling.

28. According to the mapping tool as recited in claim 9, said objects representing emotional states are represented by a particular shape and/or a particular colour.

29. According to the mapping tool as recited in claim 9 and 28, different shades of the same colour as attributed to emotional states are used to represent constructive or destructive emotional states, a light shade representing a constructive emotional state and a dark shade representing a destructive emotional state.

30. According to the mapping tool as recited in claim 10, said objects representing senses are represented by a particular shape and/or a particular colour

31. According to the mapping tool as recited in claim 11, said objects representing values or virtues are represented by a particular shape and/or a particular colour.

32. According to the mapping tool as recited in claim 12, said objects representing solutions are represented by a particular shape and/or a particular colour.

33. According to the mapping tool as recited in claim 12 and 32, different shades of the same colour as attributed to solutions may be used to represent the degree of sustainability of solutions, a light shade representing a high degree of sustainability and a dark shade representing a low degree of sustainability.

34. According to the mapping tool as recited in claim 13, said objects representing direction of movement or absence of movement are represented by a particular shape and/or a particular colour.

35. According to the mapping tool as recited in claim 1, there is provided another version of the tool where some of the pluralities of objects are shaped to represent the direction of movement or absence of movement of said objects, and/or other characteristics as may be deemed appropriate.

36. According to the mapping tool as recited in claim 1, one embodiment of the tool further comprises a magnetically attractive board on which the objects can be arranged, said objects having a magnetic backing.

37. According to the mapping tool as recited in claim 1, another embodiment further comprises an electronic display device, user interface, database, adequate hardware, provision for software to be installed, and/or operating system software.

38. According to the mapping tool as recited in claim 1 and 37, objects may be selected and positioned on the display device by a click, drag, drop and move method.

39. According to the mapping tool as recited in claim 1 and 37, the colour of one or more of the selected objects can be lightened or darkened to a different shade to represent the intensity as perceived by the user of the said objects as recited in claims 17, 19, 21, 23, 25, 27, 29 and 33.

40. According to the mapping tool as recited in claim 1, 35 and 37, the shape representing the direction of movement or absence of movement or other characteristics of said objects, can be modified on the display device accordingly.

41. According to the present invention there is provided a method of mapping a situation or relationship, comprising:
selecting one of more of a first set of objects relating to a person or group of persons, each of the first objects representing a different person or group of persons, and placing the selected object on the board or display device;
selecting one of more of the second set of objects relating to symptom, each of the second objects representing a different symptom, and placing the selected object on the board or display device in a manner that represents the symptom of each first object;
selecting one or more of the third set of objects relating to contexts, each of the third objects representing a different context, and placing the selected object on the board or display device in a manner that represents the context in which the situation or relationship is occurring for one or more of the selected first objects;
selecting one or more of the fourth set of objects relating to context areas, each of the fourth objects representing a different context area, and placing the selected object on the board or display device in a manner that represents the context area related to the selected context in which the situation or relationship is occurring;
selecting one or more of the fifth set of objects relating to themes, each of the fifth objects representing a different theme, and placing the selected object on the board or display device in a manner that represents the theme of the situation or relationship for one or more of the selected first objects;
selecting one or more of the sixth set of objects relating to behaviours, each of the sixth objects representing a different behaviour, and placing the selected object on the board or display device in a manner that represents the behaviour exhibited by one or more of the selected first objects;
selecting one or more of the seventh set of objects relating to feelings, each of the seventh objects representing a different feeling, and placing the selected object on the board or display device in a manner that represents the feeling of one or more of the selected first object in relation to one or more of the selected first object, or in relation to the situation or relationship;
selecting one or more of the eight set of objects relating to emotional states, each of the eight set of objects representing a different emotional state, and placing the selected object on the board or display device in a manner that represents the emotional state of one or more of the selected first object in relation to one or more of the selected first object, or in relation to the situation or relationship;
where some of the pluralities of objects are not shaped to represent the direction of movement or absence of movement, selecting one or more of the twelfth set of objects relating to the direction of movement or absence of movement of one or more of the previously selected objects, particularly but not limited to, the direction of movement or absence of movement of feelings, emotional states and behaviours, and placing the selected object on the board or display device in a manner that represents the direction of movement or absence of movement of one or more of the previously selected objects, particularly but not limited to, the direction of movement or absence of movement of feelings, emotional states and behaviours, and where a movement is present, placing the selected object on the board or display device in a manner that indicates the direction from which one or more of the previously selected objects towards which one or more of the previously selected objects;
wherein the arrangements of the selected objects on the board or display device form a map representing a situation or relationship;
wherein the overall shade within a particular set or category of object may be visually or electronically or by any other means measured for evaluation;
wherein the overall shade of the map may be visually or electronically or by any other means measured for evaluation;
wherein the overall map and associated measurements may be recorded and saved by manual or electronic or any other means for future access, comparison with other previously recorded and saved maps, and data analysis.

42. According to the present invention there is provided a method of selecting one or more optional object of the ninth set of object relating to senses, each of the ninth set of object representing a different sense, and placing the selected object on the board or display device in a manner that represents the senses involved of one or more of the selected first object.

43. According to the present invention there is provided a method of selecting one or more optional object of the tenth set of objects relating to values or virtues, each of the tenth objects representing a different value or virtue, and placing the selected object on the board or display device in a manner that represents the value or virtue considered important to one or more of the selected first object.

44. According to the present invention there is provided a method of selecting one or more optional object of the eleventh set of objects relating to solutions, each of the eleventh objects representing a different solution, and placing the selected object on the board or display device in a manner that represents a potential solution in relation to the context and the context area and/or in relation to the situation or relationship a whole.
In the claims of this application and in the description of the invention, except where the context requires otherwise due to express language or necessary implication, the words “comprise” or variations such as “comprises” or “comprising” are used in an inclusive sense, i.e. to specify the presence of the stated features but not preclude the presence of or addition of further features in various embodiments of the invention.
